(19) United States
(12) Patent Application Publication
(10) Pub. No.: US 2026/0202508 A1
(43) Pub. Date: Jul. 16, 2026

(54) ANTENNA DEVICE FOR A RADAR DEVICE, HAVING AT LEAST TWO ANTENNA ARRANGEMENTS, RADAR DEVICE, DRIVER ASSISTANCE SYSTEM, VEHICLE AND METHOD FOR OPERATING A RADAR DEVICE

(71) Applicant: Valeo Schalter und Sensoren GmbH, Bietigheim-Bissingen (DE)

(72) Inventors: Christian Sturm, Bietigheim-Bissingen (DE); Hamid Afrasiabi Vayghan, Bietigheim-Bissingen (DE); Leen Sit, Bietigheim-Bissingen (DE); Michal Mandlik, Prague (CZ); Miquel Testar Quer, Bietigheim-Bissingen (DE); Alan Jenkins, Bietigheim-Bissingen (DE)

(73) Assignee: Valeo Schalter und Sensoren GmbH, Bietigheim-Bissingen (DE)

(21) Appl. No.: 19/133,935

(22) PCT Filed: Nov. 27, 2023
(86) PCT No.: PCT/EP2023/083128

§ 371 Date: May 29, 2025

(30) Foreign Application Priority Data
Nov. 29, 2022 (DE) 10 2022 131 461.8

(51) Int. Cl. G01S 7/03; G01S 13/00; G01S 13/931

(52) U.S. Cl. CPC G01S 7/032; G01S 13/003; G01S 13/931; G01S 2013/93271

(57) ABSTRACT

Described is an antenna device for a radar device and a method for operating a radar device. The antenna device has a type-1 antenna element of a first antenna element type and a type-2 antenna element of a second antenna element type. One of the antenna element types is a transmit antenna element type and the other of the antenna element types is a receive antenna element type. The antenna device has two antenna arrangements that are of identical design. The positions of the antenna elements of an antenna arrangement within the antenna device result from a geometric transformation of the positions of the corresponding antenna elements of the other antenna arrangement. The geometric transformation includes a rotation of the positions of the antenna elements of the other antenna arrangement about an imaginary directional axis thereof. The imaginary directional axis indicates the direction in which the antenna arrangement is directed.

### TECHNICAL Field

The invention relates to an antenna device for a radar device, in particular for a bistatic radar device, in particular for a radar device for a vehicle, having at least one antenna arrangement that has at least one type-1 antenna element of a first antenna element type and at least one type-2 antenna element of a second antenna element type, wherein one of the antenna element types is transmit antenna elements and the other of the antenna element types is receive antenna elements.

The invention furthermore relates to a radar device, in particular a radar device for a vehicle, having at least one antenna device that comprises at least one antenna arrangement that has at least one type-1 antenna element of a first antenna element type and at least one type-2 antenna element of a second antenna element type, wherein one of the antenna element types is transmit antenna elements and the other of the antenna element types is receive antenna elements.

The invention furthermore relates to a driver assistance system having at least one radar device, in particular a bistatic radar device, which comprises at least one antenna device that has at least one antenna arrangement for the at least one radar device, wherein the at least one antenna arrangement has at least one type-1 antenna element of a first antenna element type and at least one type-2 antenna element of a second antenna element type, wherein one of the antenna element types is transmit antenna elements and the other of the antenna element types is receive antenna elements.

The invention also relates to a vehicle having at least one radar device, in particular a bistatic radar device, which comprises at least one antenna device that has at least one antenna arrangement for the at least one radar device, wherein the at least one antenna arrangement has at least one type-1 antenna element of a first antenna element type and at least one type-2 antenna element of a second antenna element type, wherein one of the antenna element types is transmit antenna elements and the other of the antenna element types is receive antenna elements.

Finally, the invention relates to a method for operating a radar device, in particular a radar device for a vehicle, in particular a bistatic radar device, having at least one antenna device, which comprises at least one antenna arrangement that has at least one type-1 antenna element of a first antenna element type and at least one type-2 antenna element of a second antenna element type, wherein, in the method, the antenna elements of one of the antenna element types are used to transmit radar signals and the antenna elements of the other antenna element type are used to receive echo signals resulting from the transmitted radar signals.

### PRIOR ART

US 2021/0184367 A1 discloses a radar unit having an arrangement of transmit antennas and receive antennas. The number of transmit antennas is 4 and the number of receive antennas is 4. The transmit antennas Tx #1 and Tx #2 form a first antenna group of transmit antennas that are identical in terms of vertical position and different in terms of horizontal position. The transmit antennas Tx #3 and Tx #4 form a second antenna group that is arranged in a position different from both the horizontal and vertical position in which the first antenna group is located. The receive antennas Rx #1 to Rx #3 form a third antenna group of receive antennas that are identical in terms of vertical position and different in terms of horizontal position. The receive antenna Rx #4 is a fourth antenna that is arranged in a position different from both the horizontal and vertical position in which the third antenna group is arranged. Moreover, the vertical position of the fourth antenna (Rx #4) is a position spaced from the vertical position of the third antenna group (Rx #1 to Rx #3).

The invention is based on the object of designing an antenna device, a radar device, a driver assistance system, a vehicle and a method of the type mentioned at the outset in which, when carrying out direction measurements using the radar system, the resolution of the direction is able to be increased.

### DISCLOSURE OF THE INVENTION

The object is achieved according to the invention, in the case of the antenna arrangement, in that the antenna device has at least two antenna arrangements that are of identical design, wherein the positions of the antenna elements of at least one of the antenna arrangements within the antenna device result from a geometric transformation of the positions of the corresponding antenna elements of at least one other of the antenna arrangements, wherein the geometric transformation comprises at least one rotation of the positions of the antenna elements of the at least one second-mentioned antenna arrangement about the imaginary directional axis thereof by a predefined angle of rotation, wherein the imaginary directional axis indicates the direction in which the antenna arrangement is directed.

According to the invention, the antenna device has at least two identically designed antenna arrangements. The positions of the antenna elements of at least one of the antenna arrangements within the antenna device result from a geometric transformation of the positions of the corresponding antenna elements of at least one other of the antenna arrangements. The geometric transformation comprises at least one rotation of the positions of the antenna elements of the second-mentioned antenna arrangement about the imaginary directional axis thereof by a predefined angle of rotation. The rotation of the positions of the antenna elements is achieved by a rotation of the entire antenna arrangement. The at least one second-mentioned antenna arrangement is thus rotated about its imaginary directional axis relative to the at least one first-mentioned antenna arrangement.

In addition to the rotation, the geometric transformation may comprise at least one tilting and/or at least one displacement of the positions of the antenna elements of the second-mentioned antenna arrangement. Tilting and/or displacement of the position of the antenna elements may be achieved by tilting and/or displacing the entire antenna arrangement. The at least two antenna arrangements are thereby able to be directed in different directions and/or spaced apart from one another.

The positions of the antenna elements of the at least one antenna arrangement may result from the positions of the corresponding antenna elements of the other antenna arrangement by way of a rotation about the directional axis and a further transformation, in particular a displacement and/or tilting of the directional axis, of the at least one second-mentioned antenna arrangement.

The directional axis of an antenna arrangement defines the direction in which antenna elements of the antenna arrangement are directed, that is to say in which the transmit antenna elements are able to transmit radar signals and from which the receive antenna elements are able to receive radar signals and echo signals.

The terms “first” and “second” for the antenna element types serve merely to make a simpler distinction, and do not mean that one of the antenna element types is prioritized. Accordingly, the additions “type-1” and “type-2” serve merely to make a simpler distinction between the two antenna element types. The type-1 antenna elements may be transmit antenna elements, and the type-2 antenna elements may be receive antenna elements, or vice versa.

The antenna device is intended for a radar device. The antenna arrangements of the antenna device may be used to transmit radar signals and to receive radar signals or echo signals. The received radar signals, in particular the echo signals resulting from the radar signals, may be converted into corresponding receive signals, in particular electrical receive signals. The receive signals may be processed using appropriate means, in particular a control and evaluation apparatus.

Advantageously, the antenna device may be designed for use in a bistatic radar device. Advantageously, the antenna device for the bistatic radar device may have two antenna arrangements. In this case, each antenna arrangement may receive its own radar signals, respectively the echo signals resulting from its own radar signals, and the radar signals or echo signals of the other antenna arrangement. It is thereby possible to obtain more information about a monitoring region captured by the radar device, in particular the surroundings of a vehicle.

The radar device may be used in vehicles, in particular motor vehicles. The radar system may advantageously be used in land vehicles, in particular automobiles, trucks, buses, motorcycles or the like, aircraft, in particular drones, and/or watercraft. The radar device may also be used in vehicles that are able to be operated autonomously or at least semi-autonomously.

The radar device may advantageously be connected to or be part of at least one electronic control device of a vehicle or of a machine, in particular a driver assistance system. At least some of the functions of the vehicle may thereby be performed autonomously or semi-autonomously.

The radar device may be used to detect stationary or moving objects, in particular vehicles, persons, animals, plants, obstacles, uneven road surfaces, in particular potholes or rocks, road boundaries, traffic signs, open spaces, in particular parking spaces, precipitation or the like, and/or movements and/or gestures.

In one advantageous embodiment,
the respective directional axes of the at least two antenna arrangements may run parallel
and/or
the respective directional axes may run perpendicular to a plane in which the antenna elements of the antenna arrangements are arranged. The at least two antenna arrangements, in particular the antenna elements of the at least two antenna arrangements, may thereby be aligned in the same direction.

In another advantageous embodiment,
the predefined angle of rotation may be 180°
and/or
the geometric transformation may comprise at least one displacement of the directional axis of the at least one antenna arrangement by a predefined distance
and/or
the at least two antenna arrangements may be arranged at a predefined distance from one another.

Advantageously, the predefined angle of rotation may be 180°. It is thereby possible to realize additional virtual antenna elements in a central part of a virtual array produced through the geometric convolution of the positions of the phase centers of the type-1 antenna elements and of the type-2 antenna elements of the at least two antenna arrangements.

Advantageously, as an alternative or in addition, the geometric transformation may comprise displacing the directional axis of the at least one antenna arrangement by a predefined distance. Advantageously, as an alternative or in addition, the at least one rotated arrangement may be arranged at a predefined distance from the at least one other antenna arrangement. It is thereby possible to realize a correspondingly larger virtual array through geometric convolution of the positions of the phase centers of the type-1 antenna elements and type-2 antenna elements. The greater the distance, the larger the virtual array. The size of the virtual array defines the aperture. The aperture may thus be enlarged by increasing the distance.

In a further advantageous embodiment, the at least two antenna arrangements may each have four type-1 antenna elements that are arranged in a plane at the corners of an imaginary planar rectangle, wherein two of the sides of the rectangle extend parallel to an imaginary first arrangement axis and form type-1 antenna element main axes and the other two sides of the rectangle extend parallel to an imaginary second arrangement axis that runs perpendicular to the first arrangement axis and form type-1 antenna element transverse axes,
and the at least two antenna arrangements each have at least two type-2 antenna elements that are arranged on different imaginary type-2 antenna element main axes that extend parallel and at a distance from one another and parallel to one of the arrangement axes.

According to the invention, four type-1 antenna elements of the first antenna element type are arranged at the four corners of a rectangle. The sides of the rectangle extend parallel to two arrangement axes that run perpendicular to one another. At least two type-2 antenna elements are arranged on type-2 antenna element main axes that extend parallel to one of the arrangement axes.

As a result of the rectangular arrangement of the type-1 antenna elements, when operating the radar system in accordance with a MIMO method, it is possible to realize a virtual antenna array having an aperture in two dimensions, in particular in azimuth and elevation, which is enlarged in comparison with the antenna arrangement. It is thus possible to achieve higher resolutions in both dimensions in the case of direction measurements. Accuracy in terms of ascertaining directions in which detected objects are located is thus able to be improved overall.

The directional resolution, in particular the angular resolution, of the radar device is directly dependent on the size of the aperture of the virtual antenna array. It is thus possible to realize a larger aperture overall with a comparatively small number of antenna elements in both dimensions, in particular in azimuth and elevation.

A rectangle within the meaning of the invention may have both identical and different side lengths. The rectangle may accordingly also be square.

Within the meaning of the invention, “parallel” means that the corresponding axes may also coincide, that is to say the axes may be parallel or truly parallel.

The terms “main axes” and “transverse axes” serve merely to make a simpler distinction and do not mean that one of the axes, in particular the main axis, is prioritized over the other axis, in particular the transverse axis. Accordingly, the additions “type-1” and “type-2” also serve merely here for simpler assignment of the axes to the corresponding antenna element types.

In a further advantageous embodiment, at least two of the type-2 antenna elements may be arranged on different imaginary type-2 antenna element transverse axes that extend parallel to one another, spaced apart and perpendicular to the type-2 antenna element main axes. The type-2 antenna elements may thereby each be spaced apart in two dimensions, namely in the direction of the type-2 antenna element main axes and in the direction of the type-2 antenna element transverse axes. It is thereby possible to realize sparse arrays, as they are known, in the virtual antenna array. Gaps thus arise in the virtual antenna array. It is thereby possible to realize a significantly larger virtual antenna array having a significantly larger aperture in two dimensions, in particular in azimuth and elevation.

In another advantageous embodiment,
each of the at least two antenna arrangements may have at least three type-2 antenna element transverse axes spaced apart from one another and at least three type-2 antenna elements, wherein at least three of the type-2 antenna elements are arranged on different type-2 antenna element transverse axes,
and/or
each of the at least two antenna arrangements may have at least three type-2 antenna elements, wherein only one of the type-2 antenna elements is arranged on at least one of the type-2 antenna element main axes and/or at least two of the type-2 antenna elements are arranged on at least one of the type-2 antenna element main axes; in particular, at least one of the type-2 antenna element transverse axes containing one of the type-2 antenna elements that is arranged alone on a type-2 antenna element main axis may not lie between two other type-2 antenna element transverse axes,
and/or
each of the at least two antenna arrangements may have at least four type-2 antenna elements, wherein only one of the type-2 antenna elements is arranged on at least one of the type-2 antenna element main axes and/or at least two of the type-2 antenna elements are arranged on at least one of the type-2 antenna element main axes, and a distance between at least one type-2 antenna element transverse axis on which there is located a type-2 antenna element that is arranged alone on the corresponding type-2 antenna element main axis and at least one adjacent type-2 antenna element transverse axis may be at most as great as the other distances between respectively adjacent type-2 antenna element transverse axes
and/or
each of the at least two antenna arrangements may have exactly four type-2 antenna elements. The aperture of the virtual antenna array may thereby be enlarged overall in the direction of the type-2 antenna element main axes.

Advantageously, only one of the type-2 antenna elements may be arranged on at least one of the type-2 antenna element main axes and/or at least two of the type-2 antenna elements may be arranged on at least one of the type-2 antenna element main axes. It is thereby possible, in combination with the rectangular arrangement of the type-1 antenna elements, to achieve a greater extent of the virtual antenna array.

Advantageously, as an alternative or in addition, at least one of the type-2 antenna element transverse axes containing one of the type-2 antenna elements that is arranged alone on a type-2 antenna element main axis may not lie between two other type-2 antenna element transverse axes. This makes it possible to realize an L-shaped, U-shaped or S-shaped arrangement of the type-2 antenna elements overall.

Advantageously, as an alternative or in addition, a distance between at least one type-2 antenna element transverse axis on which there is located a type-2 antenna element that is arranged alone on the type-2 antenna element main axis and at least one adjacent type-2 antenna element transverse axis may be at most as great as the other distances between respectively adjacent type-2 antenna element transverse axes. It is thereby possible to keep a gap that arises due to the offset of the individual antenna element with respect to the other antenna elements smaller. This makes it possible to achieve a more uniform distribution of the virtual antenna elements overall.

Advantageously, as an alternative or in addition, each of the at least two antenna arrangements may have exactly four type-2 antenna elements. Exactly four antenna elements may thereby be realized in each case for both antenna element types. This makes it possible to realize a correspondingly large number of virtual antenna elements in the virtual antenna array.

In another advantageous embodiment,
in each of the at least two antenna arrangements, the type-2 antenna element axes, in particular the type-2 antenna element main axes and the type-2 antenna element transverse axes, may extend in a common imaginary plane
and/or
in each of the at least two antenna arrangements, the type-2 antenna element axes, in particular the type-2 antenna element main axes and the type-2 antenna element transverse axes, may extend parallel to a plane spanned by the type-1 antenna element main axes and the type-1 antenna element transverse axes,
and/or
in each of the at least two antenna arrangements, the type-1 antenna elements and the type-2 antenna elements may be arranged on a common carrier, in particular a common carrier plate
and/or
all type-1 antenna element axes and type-2 antenna element axes of the antenna arrangements of the antenna device may extend in a common imaginary plane. The antenna arrangements may thereby be produced, assembled and aligned more easily.

Advantageously, in each of the at least two antenna arrangements, all type-2 antenna element axes may extend in an imaginary plane. The antenna arrangements may thereby be realized and aligned more easily.

Advantageously, as an alternative or in addition, in each of the at least two antenna arrangements, the type-2 antenna element axes may extend parallel to a plane spanned by the type-1 antenna element axes, in particular the type-1 antenna element main axes and the type-2 antenna element main axes. The alignment of the type-1 antenna elements and the arrangement of the type-2 antenna elements may thereby be simplified. Advantageously, as an alternative or in addition, in each of the at least two antenna arrangements, the type-1 antenna elements and type-2 antenna elements may be arranged on a common carrier. The antenna arrangements may thereby be produced even more easily.

Advantageously, in each at least two antenna arrangements, the type-1 antenna elements and the type-2 antenna elements may be realized on a common carrier plate, in particular a printed circuit board. All of the antenna elements may thereby be realized easily in one plane. When using a printed circuit board, electrical connections to the antenna elements may in particular be realized more easily.

Advantageously, as an alternative or in addition, all type-1 antenna element axes and type-2 antenna element axes of the antenna arrangements of the antenna devices may extend in a common imaginary plane. The antenna device may thereby be realized in a space-saving manner in the dimension perpendicular to the common plane.

In a further advantageous embodiment, in each of the at least two antenna arrangements, the phase centers of at least some of the antenna elements, in particular the phase centers of all antenna elements, may be arranged on the corresponding antenna element axes, in particular the antenna element main axes and/or the antenna element transverse axes. The positions of the antenna elements in the antenna arrangement may thereby be defined more accurately.

Advantageously, the phase center of at least some of the antenna elements of an antenna arrangement may lie at intersections of antenna element main axes with the antenna element transverse axes.

In a further advantageous embodiment, in each of the at least two antenna arrangements, a respective distance between adjacent antenna element axes for the same antenna element type, in particular a respective distance between adjacent antenna element main axes and/or a respective distance between adjacent antenna element transverse axes for the same antenna element type, may be an integer multiple of a predefined base distance, wherein the base distance corresponds to half the wavelength of radar signals transmitted using the radar system. It is thereby possible to realize particularly compact arrangements. Specifying the base distance as half the wavelength of the radar signals makes it possible to reduce ambiguities and sidelobes. Furthermore, distinctly directed radar signals may be realized on the transmitter side. In addition, distinct angle measurements may be performed.

In another advantageous embodiment,
in each of the at least two antenna arrangements, an extent of a transmit antenna element field, which consists of the antenna elements of the transmit antenna element type, in the direction of the first arrangement axis, may be greater than an extent of a receive antenna element field, which consists of the antenna elements of the receive antenna element type, in the direction of the first arrangement axis, and an extent of the transmit antenna element field in the direction of the second arrangement axis may be greater than an extent of the receive antenna element field in the direction of the second arrangement axis.

Advantageously, in each of the at least two antenna arrangements, the extent of the transmit antenna element field in the direction of both arrangement axes may be greater than the corresponding extent of the receive antenna element field. The receive antenna element field thereby fits into the transmit antenna element field, as it were. The fact that the receive antenna element field is smaller than the transmit antenna element field makes it possible to minimize ambiguities and sidelobes.

In another advantageous embodiment,
the at least two antenna arrangements may be designed for use of the radar system in accordance with a MIMO method
and/or
the type-1 antenna elements of the at least two antenna arrangements are each able to be driven and/or read separately and the type-2 antenna elements of the at least two antenna arrangements are each able to be driven and/or read separately.

Advantageously, the at least two antenna arrangements may be designed for operation of the radar device in accordance with a MIMO method. The radar device may be realized as what is known as a MIMO radar device. In a MIMO (multiple input/multiple output) method, all antenna elements of the transmit antenna element type may be used to emit differently coded radar signals. The radar signals on the receiver side may thereby be correspondingly assigned to the echo signals received using the antenna elements of the receive antenna element type. In a pure MIMO method, the aperture of the virtual antenna array realized from the antenna device may thus be enlarged correspondingly.

Advantageously, the antenna elements may each be driven and/or read separately. The number of antenna elements may thereby be utilized efficiently. In this case, transmit antenna elements may be driven separately. Receive antenna elements may be read separately. It is thus possible, even with a comparatively small number of antenna elements, to realize a virtual antenna array with a correspondingly large number of virtual antenna elements.

The object is furthermore achieved, in the case of the radar device, in that the radar device has at least one antenna device according to the invention.

The radar device has at least one antenna device that comprises at least two antenna arrangements that each have at least one type-1 antenna element of a first antenna element type and at least one type-2 antenna element of a second antenna element type. One of the antenna element types is transmit antenna elements and the other of the antenna element types is receive antenna elements.

According to the invention, the at least one antenna device has at least two antenna arrangements that are of identical design. The positions of the antenna elements of at least one of the antenna arrangements within the antenna device result from a geometric transformation of the positions of the corresponding antenna elements of at least one other of the antenna arrangements. The geometric transformation comprises at least one rotation of the positions of the antenna elements of the at least one second-mentioned antenna arrangement about the imaginary directional axis thereof by a predefined angle of rotation. The imaginary directional axis indicates the direction in which the antenna arrangement is directed.

In the at least two antenna arrangements, the type-1 antenna elements may advantageously each be arranged in a plane at the corners of an imaginary, planar rectangle. Two of the sides of the rectangle may extend parallel to an imaginary first arrangement axis and may form type-1 antenna element main axes. The other two sides of the rectangle may extend parallel to an imaginary second arrangement axis that runs perpendicular to the first arrangement axis, and may form type-1 antenna element transverse axes. At least two of the type-2 antenna elements may be arranged on different imaginary type-2 antenna element main axes that extend parallel and at a distance from one another and parallel to one of the arrangement axes.

Advantageously, the radar device may have means using which the radar device is able to be operated in accordance with a MIMO method. It is thereby possible to improve a resolution, in particular angular resolution, when determining a direction of detected objects.

Advantageously, the radar device may be a bistatic radar device. The radar device may thereby be used to ascertain more information about a monitoring region.

The object is furthermore achieved according to the invention, in the case of the driver assistance system, in that the at least one radar device has at least one antenna device according to the invention.

The at least one radar device comprises at least one antenna device that has at least one antenna arrangement. The at least one antenna arrangement has at least one type-1antenna element of a first antenna element type and at least one type-2 antenna element of a second antenna element type. One of the antenna element types is transmit antenna elements and the other of the antenna element types is receive antenna elements.

A radar device may be used to monitor at least one monitoring region in the surroundings of the vehicle for objects.

The driver assistance system may be used to operate the vehicle autonomously or semi-autonomously, in particular on the basis of the information obtained using the at least one radar device, in particular on the basis of information about objects detected using the at least one radar device.

The object is also achieved according to the invention, in the case of the vehicle, in that the at least one radar device has at least one antenna device according to the invention. The vehicle comprises at least one radar device having at least one antenna device. The at least one antenna device has at least one type-1 antenna element of a first antenna element type and at least one type-2 antenna element of a second antenna element type. One of the antenna element types is transmit antenna elements and the other of the antenna element types is receive antenna elements.

The at least one radar device may be used to monitor at least one monitoring region in the surroundings of the vehicle for objects.

Advantageously, the vehicle may have at least one bistatic radar device having two radar systems. One of the antenna arrangements of the antenna device may be assigned to each radar system. Each radar system may thereby be used to receive its own radar signals and the radar signals transmitted by the respective other antenna arrangement or the corresponding echo signals. It is thereby possible to ascertain more information about a monitoring region captured by the radar device.

The vehicle may advantageously have at least one driver assistance system, in particular at least one driver assistance system according to the invention. The driver assistance system may be used to operate the vehicle autonomously or semi-autonomously.

At least one radar device, in particular at least one radar device according to the invention, may advantageously be connected to or be part of a driver assistance system, in particular at least one driver assistance system according to the invention. Information obtained using the at least one radar device, in particular information about detected objects, may thereby be used by the driver assistance system for the autonomous or semi-autonomous operation of the vehicle.

Finally, the object is achieved according to the invention, in the case of the method, in that the radar signals are transmitted using an antenna device according to the invention and the echo signals are received using the antenna device according to the invention.

Advantageously, the radar device may be operated in accordance with a bistatic method. It is thereby possible to acquire more information about the surroundings. In the bistatic method, each antenna arrangement may receive its own radar signals, respectively the echo signals resulting from its own radar signals, and the radar signals or echo signals of the other antenna arrangement.

Advantageously, the radar device may be operated in accordance with a MIMO method. Directions of objects detected using the radar device are thereby able to be ascertained more accurately.

In other regards, the features and advantages indicated in connection with the antenna device according to the invention, the radar device according to the invention, the driver assistance system according to the invention, the vehicle according to the invention and the method according to the invention, and their respective advantageous configurations, apply correspondingly to one another, and vice versa. The individual features and advantages may of course be combined with one another, in which case further advantageous effects extending beyond the sum of the individual effects may result.

### BRIEF DESCRIPTION OF THE DRAWINGS

Further advantages, features and details of the invention will become apparent from the following description, in which exemplary embodiments of the invention are explained in more detail with reference to the drawing. Those skilled in the art will expediently also consider the features disclosed in combination in the drawing, the description and the claims individually and combine them to form further useful combinations. In the drawing, schematically,

FIG. 1 shows a plan view of a vehicle having a driver assistance system that has a radar device;

FIG. 2 shows a side view of the vehicle from FIG. 1;

FIG. 3 shows a functional illustration of the driver assistance system from FIG. 1, wherein the radar device comprises two radar systems having an antenna device that has two antenna arrangements for the radar systems;

FIG. 4 shows a front view of an antenna device for the radar device from FIGS. 1 to 3 with two antenna arrangements according to a first exemplary embodiment;

FIG. 5 shows a front view of an antenna arrangement according to a second exemplary embodiment for the antenna device for the radar device from FIGS. 1 to 3;

FIG. 6 shows a front view of an antenna device for the radar device from FIGS. 1 to 3, having two antenna arrangements according to the second exemplary embodiment from FIG. 5 and a virtual antenna array realized from the antenna device;

FIG. 7 shows a front view of an antenna arrangement according to a third exemplary embodiment for the antenna device for the radar device from FIGS. 1 to 3;

FIG. 8 shows a front view of an antenna arrangement according to a fourth exemplary embodiment for the antenna device for the radar device from FIGS. 1 to 3.

In the figures, identical components are provided with the same reference signs.

### EMBODIMENT(S) OF THE INVENTION

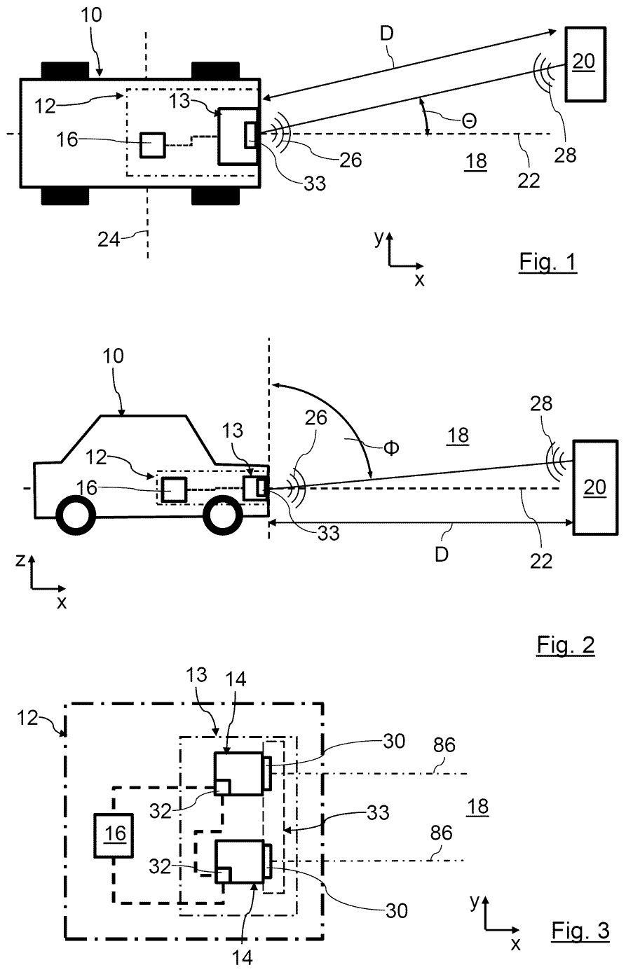

FIG. 1 shows a plan view of a vehicle 10 in the form of an automobile. FIG. 2 shows a side view of the vehicle 10.

The vehicle 10 comprises a driver assistance system 12. By way of example, the driver assistance system 12 has a radar device 13 and a control apparatus 16. FIG. 3 shows the driver assistance system 12 with the radar device 13 as a functional diagram.

The radar device 13 is arranged for example on the front side of the vehicle 10. The radar device 13 may be used to monitor a monitoring region 18 in front of the vehicle 10 for objects 20. In FIGS. 1 and 2, by way of example, an object 20 is arranged in front of the vehicle 10 and is able to be detected using the radar device 13. The radar device 13 may also be arranged elsewhere in the vehicle 10 and also be aligned differently. It is also possible to provide multiple radar devices 13 at different locations and with different alignments.

The radar device 13 may be used to ascertain object information, for example distances D, directions, for example azimuth Θ and elevation angles φ, and speeds of detected objects 20 relative to the vehicle 10.

The radar device 13 is functionally connected to the control apparatus 16 of the driver assistance system 12. Object information ascertained using the radar device 13 may thus be transmitted to the control apparatus 16. The driver assistance system 12 may be used to operate the vehicle 10 autonomously or semi-autonomously.

For simpler orientation, the corresponding coordinates of a Cartesian x-y-z coordinate system are indicated in FIGS. 1 to 8. By way of example, the x-axis of the x-y-z coordinate system runs parallel to the vehicle longitudinal axis 22 of the vehicle 10. The y-axis runs parallel to a vehicle transverse axis 24 of the vehicle 10, and the z-axis runs spatially upward perpendicular to the x-y-plane.

The radar device 13 may be used to transmit radar signals 26 into the monitoring region 18. Radar signals 26 reflected from objects 20 in the direction of the radar device 13 may be received by the radar device 13 as echo signals 28. The corresponding object information may be ascertained from the echo signals 28.

The radar device 13 comprises two radar systems 14. Each of the radar systems 14 comprises an antenna arrangement 30 and a control and evaluation apparatus 32. The two antenna arrangements 30 are combined to form a common antenna device 33. By way of example, the two antenna arrangements 30 are fixed on a common carrier.

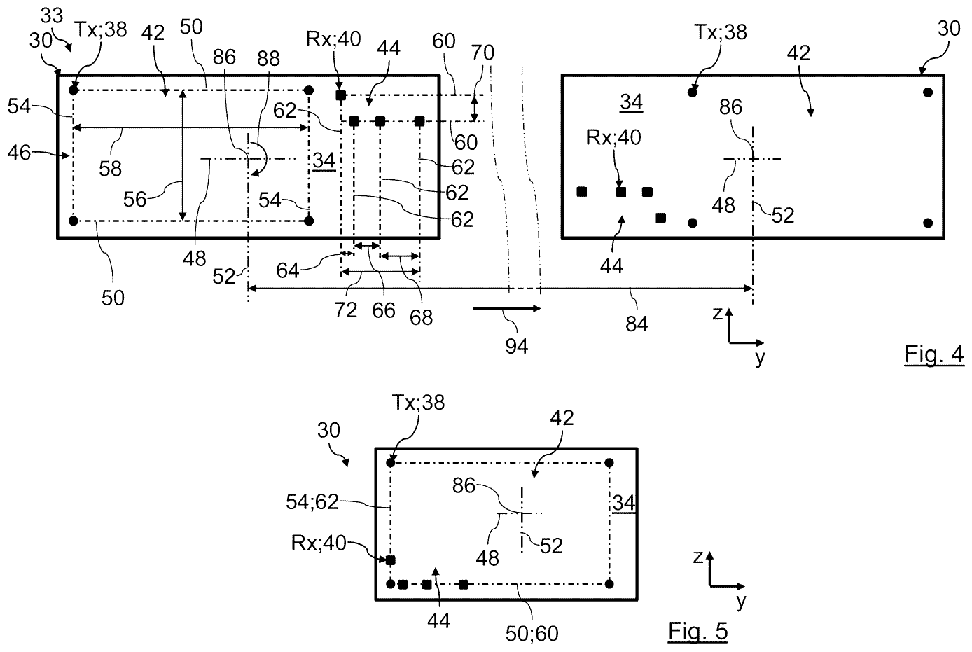

The antenna device 33 comprising two antenna arrangements 30 according to a first exemplary embodiment is illustrated in FIG. 4 in a front view as viewed from the monitoring region 18.

The antenna device 33 comprises two antenna element types, namely transmit antenna elements Tx and receive antenna elements Rx. The transmit antenna elements Tx may be used to transmit radar signals 26. The receive antenna elements Rx may be used to receive echo signals 28.

The two antenna arrangements 30 of the antenna device 33 are of identical design. Within the antenna device 33, the two antenna arrangements 30, as will be explained in more detail below, are rotated relative to one another by 180° and displaced in relation to one another in the direction of the y-axis.

Each of the antenna arrangements 30 has four transmit antenna elements Tx and four receive antenna elements Rx. The transmit antenna elements Tx and the receive antenna elements Rx of each antenna arrangement 30 are arranged on a common carrier in the form of a carrier plate 34. The antenna device 33 thus has two carrier plates 34. The two carrier plates 34 may be fastened to a common carrier, in a manner of no further interest here.

The control and evaluation apparatuses 32 may be used to drive the transmit antenna elements Tx of the respective antenna arrangement 30 so as to emit radar signals 26. In addition, the control and evaluation apparatuses 32 may be used to acquire and evaluate the echo signals 28 that are received using the receive antenna elements Rx of the respective antenna arrangement 30 and converted to electrical receive signals. The control and evaluation apparatuses 32 may be used to ascertain the corresponding object information from the electrical receive signals and to transmit said information to the control apparatus 16.

Furthermore, the control and evaluation apparatuses 32 of the two antenna arrangements 30 are signal-connected to one another. The radar systems 14 may thus be synchronized. The radar device 13 is operated in accordance with a bistatic method. In the bistatic method, each of the antenna arrangements 30 may receive its own radar signals 26 or corresponding echo signals 28 and the echo signals 28 that originate from the radar signals 26 of the respective other antenna arrangement 30.

The radar systems 14 are operated in accordance with a MIMO (multiple-input multiple-output) method. In the MIMO method, the transmit antenna elements Tx are driven separately with transmission control signals by the control and evaluation apparatuses 32. Corresponding transmission control signals are used to distinguish the radar signals 26 transmitted using the individual transmit antenna elements Tx, for example by coding. It is thus possible, on the receiver side, for signal paths of the radar signals 26 and the corresponding echo signals 28 to be assigned to the respective transmit antenna elements Tx. The receive antenna elements Rx are accordingly read separately. In this case, the electrical receive signals converted from the echo signals 28 by the antenna elements Rx are assigned accordingly. The separate driving or reading makes it possible to use all positions of the transmit antenna elements Tx and all positions of the receive antenna elements Rx to realize a virtual antenna array 36.

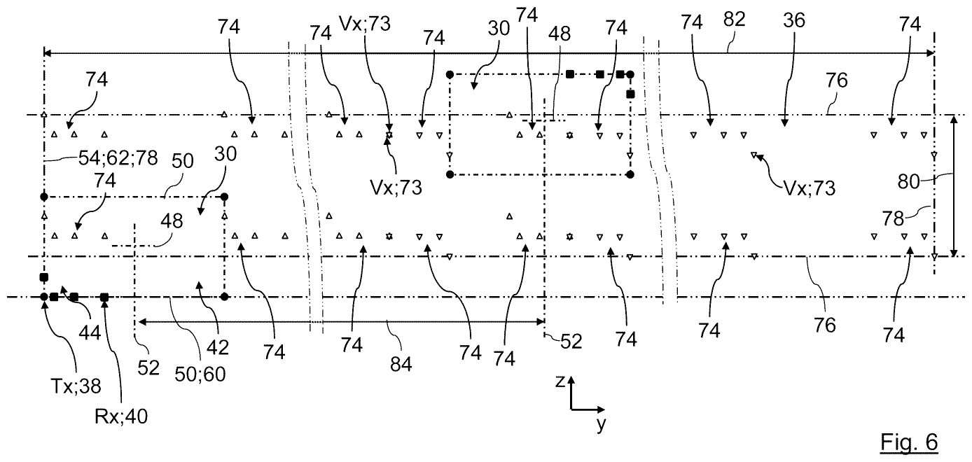

FIG. 6 shows, by way of example, the virtual antenna array 36, which may be realized by an antenna device 33 having antenna arrangements 30 according to a second exemplary embodiment, which is shown in FIG. 5. The virtual antenna array 36 shown in FIG. 6 may also be realized with the antenna device 33 having the antenna arrangements 30 according to the first exemplary embodiment from FIG. 4.

In FIGS. 4 to 8, the transmit antenna elements Tx with their phase centers 38 are indicated as black-filled circles. The receive antenna elements Rx with their phase centers 40 are indicated as black-filled squares. For better clarity, only some of the transmit antenna elements Tx and their phase centers 38 and only some of the receive antenna elements Rx and their phase centers 40 are provided with reference signs.

FIG. 4 shows the two antenna arrangements 30 of the antenna device 33. As already mentioned, the antenna arrangements 30 are of identical design.

The antenna arrangements 30, viewed in the direction of the y-axis, are arranged at a distance 84 at the same height viewed in the direction of the z-axis. The distance 84 is, by way of example, the distance between respective centers of the antenna arrangements 30. The distance 84 is an integer multiple of a predefined base distance λ/2. The base distance λ/2 corresponds to half the wavelength λ/2 of radar signals 26 transmitted using the radar system 14. By way of example, the distance 84 is 400 times the base distance, that is to say 200λ. In FIG. 4, the distance 84 is not illustrated to scale.

Both antenna arrangements 30 are directed in the same direction, namely in the direction of the monitoring region 18. Respective directional axes 86 of the antenna arrangements 30 run parallel to one another, as shown in FIG. 3. The directional axes 86 indicate the direction with reference to the antenna device 33 in which the respective antenna arrangement 30 is directed. In FIG. 4, the directional axes 86 run perpendicular to the plane of the drawing. The right-hand antenna arrangement 30 in FIG. 4 is rotated by a rotation 88 by an angle of rotation of 180° about its directional axis 86 in comparison with the left-hand antenna arrangement 30.

The positions of the transmit antenna elements Tx and receive antenna elements Rx of the right-hand antenna arrangement 30 result from a geometric transformation of the positions of the corresponding transmit antenna elements Tx and receive antenna elements Rx of the left-hand antenna arrangement 30. The geometric transformation comprises the rotation 88 about the directional axis 86 with the angle of rotation of 180° and a displacement 94 in the direction of the y-axis by the distance 84. The rotation 88 of the positions of the transmit antenna elements Tx and of the receive antenna elements Rx is achieved by the rotation of the antenna arrangement 30.

The two antenna arrangements 30 are described below using the example of the left-hand antenna arrangement 30 in FIG. 4.

The antenna arrangement 30 has a transmit antenna element field 42 consisting of the four transmit antenna elements Tx and a receive antenna element field 44 consisting of the four receive antenna elements Rx. In the antenna arrangement 30 shown in FIG. 4, the receive antenna element 44 is arranged to the right outside the transmit antenna element 42. The transmit antenna element field 42 and the receive antenna element field 44 may also be arranged differently in relation to one another. The transmit antenna element field 42 and the receive antenna element field 44 may also overlap, as shown in a second exemplary embodiment in FIG. 5 and.

The transmit antenna elements Tx are arranged in a transmission plane at the corners of an imaginary planar rectangle 46. The rectangle 46 has different side lengths. The two longer sides of the rectangle 46 extend parallel to an imaginary first arrangement axis 48, which runs horizontally and parallel to the y-axis in FIG. 4, and form imaginary transmit antenna element main axes 50. The other two, shorter sides of the rectangle 46 extend parallel to an imaginary second arrangement axis 52, which runs vertically and parallel to the z-axis in FIG. 4, and form imaginary transmit antenna element transverse axes 54. The second arrangement axis 52 runs perpendicular to the first arrangement axis 48. The transmit antenna elements Tx thus form the rectangular transmit antenna element field 42.

The directional axis 86 runs perpendicular to the plane spanned by the first arrangement axis 48 under second arrangement axis 52.

The phase centers 38 of the transmit antenna elements Tx are arranged at the intersections of the transmit antenna element main axes 50 with the corresponding transmit antenna element transverse axes 54.

A respective distance between the adjacent transmit antenna element main axes 50 or between the adjacent transmit antenna element transverse axes 54, that is to say between the respectively adjacent antenna element axes for the same antenna element type, is an integer multiple of the predefined base distance λ/2.

In the exemplary embodiment shown in FIG. 4, the distance 56 between the transmit antenna element main axes 50 corresponds to ten times the base distance λ/2, that is to say 5λ. The distance 58 between the transmit antenna element transverse axes 54 corresponds to 18 times the base distance λ/2, that is to say 9λ.

The phase centers 40 of the four receive antenna elements Rx are arranged in a manner distributed over two imaginary receive antenna element main axes 60 and four imaginary receive antenna element transverse axes 62. In this case, the phase centers 40 are each arranged at an intersection of a receive antenna element main axis 60 with a receive antenna element transverse axis 62.

The receive antenna element main axes 60 extend parallel to one another, spaced apart and parallel to the first arrangement axis 48. The four receive antenna element transverse axes 62 extend parallel to one another, spaced apart, perpendicular to the receive antenna element main axes 60 and parallel to the second arrangement axis 52.

The receive antenna element main axes 60 and the receive antenna element transverse axes 62 extend in an imaginary reception plane. The receive antenna element main axes 60 and the receive antenna element transverse axes 62, that is to say the reception plane, also extend parallel to a plane spanned by the transmit antenna element main axes 50 and the transmit antenna element transverse axes 54. The reception plane containing the receive antenna element main axes 60 and the receive antenna element transverse axes 62 extends parallel to the transmission plane containing the transmit antenna element main axes 50 and the transmit antenna element transverse axes 54.

In the exemplary embodiment shown in FIG. 4, the receive antenna element main axes 60, the receive antenna element transverse axes 62, the transmit antenna element main axes 50 and the transmit antenna element transverse axes 50 are located in a common plane. Accordingly, all transmit antenna elements Tx and all receive antenna elements Rx are located in the common plane.

The phase center 40 of one of the receive antenna elements Rx is arranged on one of the receive antenna element main axes 60, the upper receive antenna element main axis 60 in FIG. 4. The phase centers 40 of the other three receive antenna elements Rx are each arranged on the other, lower receive antenna element main axis 60. The phase centers 40 of the four receive antenna elements Rx are arranged on different receive antenna element transverse axes 62.

The receive antenna element transverse axis 62 on which the phase center 40 of the receive antenna element Rx that is arranged alone on the upper receive antenna element main axis 60 is located lies on the left-hand side of the receive antenna element field 44, that is to say not between two other receive antenna element transverse axes 62.

A respective distance between the adjacent receive antenna element main axes 60 or between the adjacent receive antenna element transverse axes 62, that is to say between the respectively adjacent antenna element axes for the same antenna element type, is an integer multiple of the base distance λ/2. All distances between the respectively adjacent receive antenna element transverse axes 62 are different.

A distance 64 between the receive antenna element transverse axis 62 on which the phase center 40 of the single receive antenna element Rx that is arranged alone on the corresponding receive antenna element main axis 60 is located, on the left-hand side of the receive antenna element field 44 in FIG. 4, and the adjacent second receive antenna element transverse axis 62 from the left is smaller than the other distances 66 and 68 between respectively adjacent other receive antenna element transverse axes 62.

In the exemplary embodiment shown in FIG. 4, the distance 70 between the receive antenna element main axes 60 corresponds to twice the base distance λ/2, that is to say λ. The distance 64 between the receive antenna element transverse axis 62 containing the single receive antenna element Rx on the left-hand side of the receive antenna element field 44 and the adjacent, second receive antenna element transverse axis 62 corresponds to one times the base distance λ/2. The distance 66 between the second receive antenna element transverse axis 62 and the third receive antenna element transverse axis 62 from the left corresponds to twice the base distance λ/2, that is to say λ. The distance 68 between the third receive antenna element transverse axis 62 from the left and the fourth receive antenna element transverse axis 62 from the left, that is to say the receive antenna element transverse axis 62 on the right-hand side of the receive antenna field 44 in FIG. 4, corresponds to three times the base distance λ/2, that is to say 1.5λ.

The longer sides of the rectangle 46 of the transmit antenna elements Tx, that is to say the longer sides of the transmit antenna element field 42, run parallel to the arrangement axis along which the receive antenna element axes, in the direction of which the receive antenna element field 40 has the greatest extent, also run. In the exemplary embodiment shown, the transmit antenna element main axes 50 and the receive antenna element main axes 60 run parallel to one another and parallel to the first arrangement axis 48.

An extent of the transmit antenna element field 42 in the direction of the first arrangement axis 48 is greater than an extent 72 of the receive antenna element field 44 in the direction of the first arrangement axis 48. In the exemplary embodiment shown in FIG. 4, the extent of the transmit antenna element field 42 in the direction of the first arrangement axis 48 corresponds to the distance 58 between the transmit antenna element transverse axes 54, that is to say 18 times the base distance λ/2, that is to say 9λ. The extent 72 of the receive antenna element field 44 in the direction of the first arrangement axis 48 corresponds to the sum of the distances 64, 66 and 68 between the receive antenna element transverse axes 62, that is to say six times the base distance λ/2, that is to say 3λ.

An extent of the transmit antenna element field 42 in the direction of the second arrangement axis 52 is greater than an extent of the receive antenna element field 44 in the direction of the second arrangement axis 52. In the exemplary embodiment shown, the extent of the transmit antenna element field 42 in the direction of the second arrangement axis 52 corresponds to the distance 56 between the transmit antenna element main axes 50, that is to say ten times the base distance λ/2, that is to say 5λ. The extent of the receive antenna field 44 in the direction of the second arrangement axis 52 corresponds to the distance 70 between the receive antenna element main axes 60, that is to say twice the base distance λ/2, that is to say λ.

FIG. 5 shows an antenna arrangement 30 according to a second exemplary embodiment. The second exemplary embodiment of the antenna arrangement 30 comprises the transmit antenna element field 42 and the receive antenna element field 44 of the first exemplary embodiment of the antenna arrangements 30 from FIG. 4. In contrast to the antenna arrangements 30 according to the first exemplary embodiment from FIG. 4, in the second exemplary embodiment, the receive antenna element field 44 is placed within the transmit antenna element field 42. In this case, the lower transmit antenna element main axis 50 and the lower receive antenna element main axis 60 coincide. Furthermore, the left-hand transmit antenna element transverse axis 54 and the left-hand receive antenna element transverse axis 62 coincide.

The receive antenna element field 44 is arranged such that the left-hand lower transmit antenna element Tx is located at the intersection of the lower receive antenna element main axis 60 with the left-hand receive antenna element transverse axis 62. The left-hand lower transmit antenna element Tx is located, as it were, in the gap of the receive antenna element field 44 that results due to the upward offset of the left-hand receive antenna element Rx with respect to the upper receive antenna element main axis 60. Overall, the alternative antenna arrangement 30 from FIG. 5 is of more space-saving design than the antenna arrangements 30 from FIG. 4.

The virtual antenna array 36 illustrated in FIG. 6 is able to be realized both with an antenna device 33 having two antenna arrangements 30 according to the first exemplary embodiment from FIG. 4 and with an antenna device 33 having two antenna arrangements 30 according to the second exemplary embodiment from FIG. 5.

FIG. 6 shows the antenna device 33 having two of the antenna arrangements 30 according to the second exemplary embodiment from FIG. 5 and the virtual antenna array 36 able to be realized thereby. In this case, analogously to the antenna device 33 from FIG. 4, the right-hand antenna arrangement 30 is rotated by 180° about its directional axis 86. Furthermore, the right-hand antenna arrangement 30 is displaced to the right by the distance 84 of 200λ in the direction of the y-axis and additionally upward in the direction of the z-axis. The illustration in FIG. 6 is not to scale in the direction of the y-axis.

For the antenna arrangement 30 according to the second exemplary embodiment from FIG. 5 and correspondingly with the antenna arrangement 30 according to the first exemplary embodiment from FIG. 4, the antenna array 36 with a total of 64 virtual antenna elements Vx is produced during operation of the radar system 14. The virtual antenna array 36 is realized through geometric convolution of the geometric positions of the phase centers 38 of the transmit antenna elements Tx and of the phase centers 40 of the receive antenna elements Rx of the two antenna arrangements 30 of the antenna device 33. The virtual antenna elements Vx act as virtual receive antenna elements for the echo signals 28.

FIG. 6 illustrates the virtual antenna elements Vx of the virtual antenna array 36 with their respective virtual phase centers 73 as white-filled triangles. For better clarity, only some of the virtual antenna elements Vx and of the corresponding phase centers 73 are provided with reference signs by way of example in FIG. 6.

The virtual antenna array 36 comprises 16 virtual antenna element fields 74 each having four virtual antenna elements Vx. The virtual antenna element fields 74 are of identical design, of the same size and have the same alignment. Eight of the antenna element fields 74 have the same orientation as the receive antenna element field 44 of the left-hand antenna arrangement 30. The other eight antenna element fields 74 are rotated by 180° and have the same orientation as the receive antenna element field 44 of the right-hand antenna arrangement 30 rotated by 180°.

The four virtual antenna elements Vx of each virtual antenna element field 74 are arranged in accordance with the four receive antenna elements Rx of the antenna arrangement 30 or of the antenna arrangement 30 rotated by 180°.

The virtual antenna element fields 74 are arranged in two rows each containing eight antenna element fields 74. The rows each extend parallel to the first arrangement axes 48, that is to say parallel to the y-axis. In this case, in each case two of the virtual antenna element fields 74 are arranged one below the other in the respective rows.

In both rows, in each case the first, second, third and fifth virtual antenna element fields 74 from the left, as viewed in the direction of the arrangement axes 48, are oriented in accordance with the receive antenna element field 44 of the left-hand antenna arrangement 30. The fourth, sixth, seventh and eighth virtual antenna element fields 74, as viewed in the direction of the arrangement axes 48, are oriented in accordance with the receive antenna element field 44 of the right-hand antenna arrangement 30, that is to say rotated by 180° in comparison with the left-hand antenna element fields 74.

In both rows, the third and fourth virtual antenna element fields 74 from the left each overlap one another. The respective right-hand virtual antenna element fields Vx of the third virtual antenna element fields 74 coincide with the respective left-hand virtual antenna elements Vx of the fourth virtual antenna element fields 74. In addition, the fifth and sixth virtual antenna element fields 74 from the left each overlap one another. The respective right-hand virtual antenna element fields Vx of the fifth virtual antenna element fields 74 coincide with the respective left-hand virtual antenna elements Vx of the sixth virtual antenna element fields 74.

The coinciding virtual antenna elements Vx may additionally be used to synchronize phases between radar signals 26 of the two radar systems 14. An echo signal 28 coming from an object 20 generates the same phase on both coincident virtual antenna elements Vx.

The virtual phase centers 73 of the topmost virtual antenna elements Vx of the virtual antenna array 36 in FIG. 6 lie on an upper virtual main axis 76. The phase centers 73 of the bottommost virtual antenna elements Vx lie on a lower virtual main axis 76. A distance 80 between the upper virtual main axis 76 and the lower virtual main axis 76 indicates the aperture of the virtual antenna array 36 in this direction, for example in the vertical direction, in the direction of the z-axis. The distance 80 and thus the vertical aperture corresponds to 14 times the base distance λ/2, that is to say 7λ.

The virtual phase centers 73 of the leftmost virtual antenna elements Vx of the virtual antenna array 36 in FIG. 6 lie on a left-hand virtual transverse axis 78. The left-hand virtual transverse axes 78 coincide, in the example, with the left-hand transmit antenna element transverse axis 54 and the left-hand receive antenna element transverse axes 62 of the left-hand antenna arrangement 30. The phase centers 73 of the rightmost virtual antenna elements Vx lie on a right-hand virtual transverse axis 78. A distance 82 between the left-hand virtual transverse axis 78 and the right-hand virtual transverse axis 78 indicates the aperture of the virtual antenna array 36 in this direction, for example in the horizontal direction, in the direction of the y-axis. The distance 82 and thus the horizontal aperture is greater than 800 times the base distance, that is to say >400λ. The distance 82 is more than twice as great as the distance 84 between the antenna arrangements 30.

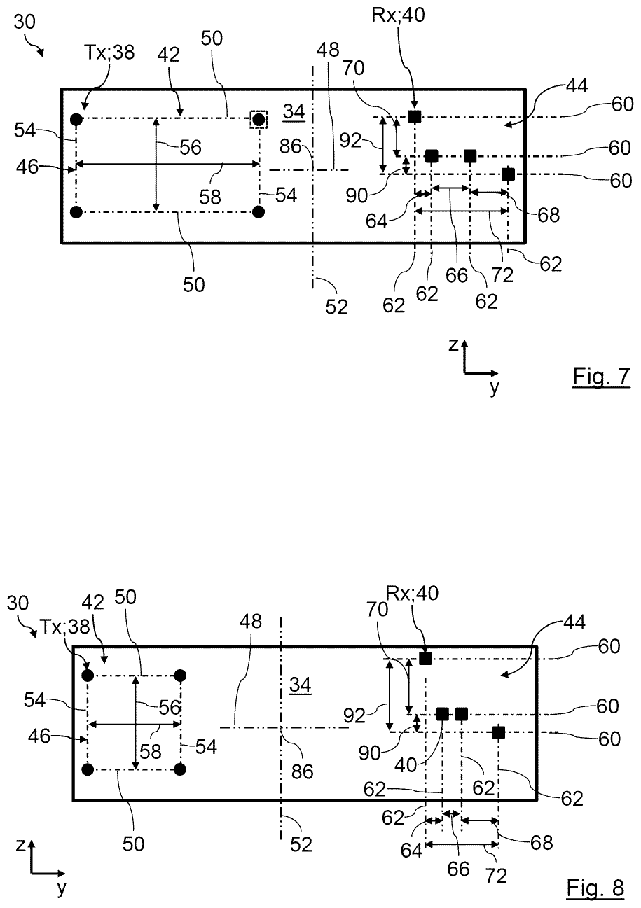

FIG. 7 shows an antenna arrangement 30 according to a third exemplary embodiment for an antenna device 33. Those elements that are similar to those of the first exemplary embodiment from FIG. 4 are provided with the same reference signs. The third exemplary embodiment differs from the first exemplary embodiment in that the phase centers 40 of the four receive antenna elements Rx are arranged in a manner distributed over three imaginary receive antenna element main axes 60 and four imaginary receive antenna element transverse axes 62. In this case, the phase centers 40 are each arranged at an intersection of a receive antenna element main axis 60 with a receive antenna element transverse axis 62.

The phase center 40 of one of the receive antenna elements Rx is arranged on one of the receive antenna element main axes 60, the upper receive antenna element main axis 60 in FIG. 7. The phase center 40 of another receive antenna element Rx is arranged on another of the receive antenna element main axes 60, the lower receive antenna element main axis 60 in FIG. 7. The phase centers 40 of the two further receive antenna elements Rx are arranged on the third, central receive antenna element main axis 60. The phase centers 40 of the four receive antenna elements Rx are arranged on different receive antenna element transverse axes 62.

The receive antenna element transverse axis 62 on which the phase center 40 of the receive antenna element Rx that is arranged alone on the upper receive antenna element main axis 60 is located lies on the left-hand side of the receive antenna element field 44, that is to say not between two other receive antenna element transverse axes 62. The receive antenna element transverse axis 62 on which the phase center 40 of the receive antenna element Rx that is arranged alone on the lower receive antenna element main axis 60 is located lies on the right-hand side of the receive antenna element field 44, that is to say not between two other receive antenna element transverse axes 62.

One of the receive antenna elements Rx is arranged in each case on the two outer antenna element transverse axes 62 of the receive antenna element field 44. The receive antenna elements Rx that lie on the two outer antenna element transverse axes 62 each lie on one of the two outer antenna element main axes 60. In the exemplary embodiment from FIG. 7, the single receive antenna element Rx at the top left in the receive antenna field 44 lies at the intersection of the upper receive antenna element main axis 60 and the left-hand receive antenna element transverse axis 62. The single receive antenna element Rx at the bottom right in the receive antenna field 44 is located at the intersection of the lower receive antenna element main axis 60 and the right-hand receive antenna element transverse axis 62. The two outer receive antenna elements Rx are arranged on diagonally opposing sides of the receive antenna field 44.

The distance 70 between the upper receive antenna element main axis 60 in FIG. 7 and the central receive antenna element main axis 60, on the one hand, and a distance 90 between the central receive antenna element main axis 60 and the lower receive antenna element main axis 60, are different.

In the third exemplary embodiment shown in FIG. 7, the distance 70 between the upper receive antenna element main axis 60 and the central receive antenna element main axis 60 corresponds to three times the base distance λ/2, that is to say 1.5λ. The distance 90 between the central receive antenna element main axis 60 and the lower receive antenna element main axis 60 corresponds to the base distance λ/2. An extent 92 of the receive antenna element field 44 in the direction of the second arrangement axis 52, that is to say in the vertical direction (z-axis), corresponds to the sum of the distances 70 and 90 between the receive antenna element main axes 60. In the exemplary embodiment shown, the extent 92 corresponds to four times the base distance λ/2, that is to say 2λ.

The distance 66 between the second receive antenna element transverse axis 62 from the left in FIG. 7 and the third receive antenna element transverse axis 62 corresponds to the distance 68 between the third receive antenna element transverse axis 62 and the fourth antenna element transverse axis 62. The distance 64 between the first receive antenna element transverse axis 62 and the second receive antenna element transverse axis 62 and the distances 66 and 68 between the other respectively adjacent receive antenna element transverse axes 62 are different.

The distance 64 between the receive antenna element transverse axis 62 on which the phase center 40 of the single receive antenna element Rx that is arranged alone on the upper receive antenna element main axis 60 is located, on the left-hand side of the receive antenna element field 44 in FIG. 7, and the adjacent second receive antenna element transverse axis 62 from the left is smaller than the other distances 66 and 68 between respectively adjacent other receive antenna element transverse axes 62.

The distance 64 between the receive antenna element transverse axis 62 containing the single receive antenna element Rx on the left-hand side of the receive antenna element field 44 and the adjacent, second receive antenna element transverse axis 62 corresponds to one times the base distance λ/2. The distance 66 between the second receive antenna element transverse axis 62 and the third receive antenna element transverse axis 62 from the left corresponds to twice the base distance λ/2, that is to say λ. The distance 68 between the third receive antenna element transverse axis 62 from the left and the fourth receive antenna element transverse axis 62 from the left, that is to say the receive antenna element transverse axis 62 on the right-hand side of the receive antenna field 44 in FIG. 7, corresponds to twice the base distance λ/2, that is to say λ.

The extent 72 of the receive antenna element field 44 in the direction of the first arrangement axis 48 corresponds to the sum of the distances 64, 66 and 68 between the receive antenna element transverse axes 62, that is to say five times the base distance λ/2, that is to say 2.5λ.

FIG. 8 shows an antenna arrangement 30 according to a fourth exemplary embodiment for the antenna device 33. Those elements that are similar to those of the third exemplary embodiment from FIG. 7 are provided with the same reference signs. The fourth exemplary embodiment differs from the third exemplary embodiment in that the transmit antenna elements Tx are arranged at the corners of an imaginary planar rectangle 46 that has identical side lengths. The rectangle 46 is thus a square. The transmit antenna elements Tx thus form a square transmit antenna element field 42.

In the fourth exemplary embodiment shown in FIG. 8, the distance 56 between the transmit antenna element main axes 50 corresponds to five times the base distance λ/2, that is to say 2.5λ. The distance 58 between the transmit antenna element transverse axes 54 likewise corresponds to five times the base distance λ/2, that is to say 2.5λ.

The distance 70 between the upper receive antenna element main axis 60 and the central receive antenna element main axis 60 corresponds to three times the base distance λ/2, that is to say 1.5λ. The distance 90 between the central receive antenna element main axis 60 and the lower receive antenna element main axis 60 corresponds to one times the base distance λ/2.

The distance 64 between the receive antenna element transverse axis 62 on the left-hand side of the receive antenna element field 44 and the adjacent, second receive antenna element transverse axis 62 corresponds to one times the base distance λ/2. The distance 66 between the second receive antenna element transverse axis 62 and the third receive antenna element transverse axis 62 from the left likewise corresponds to one times the base distance λ/2. The distance 68 between the third receive antenna element transverse axis 62 from the left and the fourth receive antenna element transverse axis 62 from the left, that is to say the receive antenna element transverse axis 62 on the right-hand side in the receive antenna element field 44 in FIG. 8, corresponds to twice the base distance λ/2, that is to say λ.

The extent 72 of the receive antenna element field 44 in the direction of the first arrangement axis 48, that is to say in the horizontal direction, corresponds to the sum of the distances 64, 66 and 68 between the receive antenna element transverse axes 62, that is to say four times the base distance λ/2, that is to say 2λ. The extent 92 of the receive antenna element field 44 in the direction of the second arrangement axis 52, that is to say in the vertical direction, corresponds to the sum of the distances 70 and 90 between the receive antenna element main axes 60, that is to say four times the base distance λ/2, that is to say 2λ. The extent 72 of the receive antenna element field 44 in the horizontal direction thus corresponds to the extent 92 in the vertical direction.

In the antenna arrangements 30 according to the third exemplary embodiment from FIG. 7 and the fourth exemplary embodiment from FIG. 8, analogously to the first exemplary embodiment from FIG. 4, the respective receive antenna element fields 44 and the transmit antenna element fields 42 may overlap. Moreover, an antenna device 33 is able to be realized analogously to the first exemplary embodiment from FIG. 4 with in each case two of the corresponding antenna arrangements 30.

1. An antenna device for a radar device for a vehicle, comprising:
at least one antenna arrangement that has at least one type-1 antenna element of a first antenna element type and at least one type-2 antenna element of a second antenna element type,
wherein one of the antenna element types is transmit antenna elements and the other of the antenna element types is receive antenna elements; and
at least two antenna arrangements that are of identical design,
wherein positions of the antenna elements of at least one of the antenna arrangements within the antenna device result from a geometric transformation of positions of corresponding antenna elements of at least one other of the antenna arrangements,
wherein the geometric transformation comprises at least one rotation of the positions of the antenna elements of the at least one second-mentioned antenna arrangement about an imaginary directional axis thereof by a predefined angle of rotation, and
wherein the imaginary directional axis indicates a direction in which the antenna arrangement is directed.

2. The antenna device as claimed in claim 1, wherein the respective directional axes of the at least two antenna arrangements run parallel and/or the respective directional axes run perpendicular to a plane in which the antenna elements of the antenna arrangements are arranged.

3. The antenna device as claimed in claim 1, wherein the predefined angle of rotation is 180° and/or the geometric transformation comprises at least one displacement of the directional axis of the at least one antenna arrangement by a predefined distance and/or the at least two antenna arrangements are arranged at a predefined distance from one another.

4. The antenna device as claimed in claim 1, wherein the at least two antenna arrangements each have four type-1 antenna elements that are arranged in a plane at corners of an imaginary planar rectangle,
wherein two of the sides of the rectangle extend parallel to an imaginary first arrangement axis and form type-1 antenna element main axes and the other two sides of the rectangle extend parallel to an imaginary second arrangement axis that runs perpendicular to the first arrangement axis and form type-1 antenna element transverse axes, and
the at least two antenna arrangements each have at least two type-2 antenna elements that are arranged on different imaginary type-2 antenna element main axes that extend parallel and at a distance from one another and parallel to one of the arrangement axes.

5. The antenna device as claimed in claim 4, wherein at least two of the type-2 antenna elements are arranged on different imaginary type-2 antenna element transverse axes that extend parallel to one another, spaced apart and perpendicular to the type-2 antenna element main axes.

6. The antenna device as claimed in claim 5, wherein each of the at least two antenna arrangements has at least three type-2 antenna element transverse axes spaced apart from one another and at least three type-2 antenna elements, wherein at least three of the type-2 antenna elements are arranged on different type-2 antenna element transverse axes, and/or
each of the at least two antenna arrangements has at least three type-2 antenna elements, wherein only one of the type-2 antenna elements is arranged on at least one of the type-2 antenna element main axes, and/or
at least two of the type-2 antenna elements are arranged on at least one of the type-2 antenna element transverse axes containing one of the type-2 antenna elements that is arranged alone on a type-2 antenna element main axis that does not lie between two other type-2 antenna element transverse axes, and/or
each of the at least two antenna arrangements has at least four type-2 antenna elements, wherein only one of the type-2 antenna elements is arranged on at least one of the type-2 antenna element main axes, and/or
at least two of the type-2 antenna elements are arranged on at least one of the type-2 antenna element main axes, and a distance between at least one type-2 antenna element transverse axis on which there is located a type-2 antenna element that is arranged alone on the corresponding type-2 antenna element main axis and at least one adjacent type-2 antenna element transverse axis is at most as great as the other distances between respectively adjacent type-2 antenna element transverse axes, and/or
each of the at least two antenna arrangements has exactly four type-2 antenna elements.

7. The antenna device as claimed in claim 4, wherein in each of the at least two antenna arrangements, the type-2 antenna element main axes and the type-2 antenna element transverse axes extend in a common imaginary plane, and/or
in each of the at least two antenna arrangements, the type-2 antenna element main axes and the type-2 antenna element transverse axes extend parallel to a plane spanned by the type-1 antenna element main axes and the type-1 antenna element transverse axes, and/or
in each of the at least two antenna arrangements, the type-1 antenna elements and the type-2 antenna elements are arranged on a common carrier plate, and/or
all type-1 antenna element axes and type-2 antenna element axes of the antenna arrangements of the antenna device extend in a common imaginary plane.

8. The antenna device as claimed in claim 5, wherein in each of the at least two antenna arrangements, phase centers of all antenna elements, are arranged on the antenna element main axes and/or the antenna element transverse axes.

9. The antenna device as claimed in claim 5, wherein in each of the at least two antenna arrangements, a respective distance between adjacent antenna element main axes and/or a respective distance between adjacent antenna element transverse axes for the same antenna element type is an integer multiple of a predefined base distance, wherein the base distance corresponds to half the wavelength of radar signals transmitted using the radar system.

10. The antenna device as claimed in claim 4,
wherein in each of the at least two antenna arrangements, an extent of a transmit antenna element field, which consists of the antenna elements of the transmit antenna element type, in the direction of the first arrangement axis, is greater than an extent of a receive antenna element field, which consists of the antenna elements of the receive antenna element type, in the direction of the first arrangement axis, and an extent of the transmit antenna element field in the direction of the second arrangement axis is greater than an extent of the receive antenna element field in the direction of the second arrangement axis.

11. The antenna device as claimed in claim 1,
wherein the at least two antenna arrangements are designed for use of the radar system in accordance with a MIMO method, and/or
the type-1 antenna elements of the at least two antenna arrangements are each able to be driven and/or read separately and the type-2 antenna elements of the at least two antenna arrangements are each able to be driven and/or read separately.

12. A radar device for a vehicle having at least one antenna device, comprising:
at least one antenna arrangement that has at least one type-1 antenna element of a first antenna element type and at least one type-2 antenna element of a second antenna element type, wherein one of the antenna element types is transmit antenna elements and the other of the antenna element types is receive antenna elements,
wherein the radar device has at least one antenna device as claimed in claim 1.

13. A driver assistance system having at least one radar device, comprises comprising:
at least one antenna device that has at least one antenna arrangement for the at least one radar device,
wherein the at least one antenna arrangement has at least one type-1 antenna element of a first antenna element type and at least one type-2 antenna element of a second antenna element type, wherein one of the antenna element types is transmit antenna elements and the other of the antenna element types is receive antenna elements,
wherein the at least one radar device has at least one antenna device as claimed in claim 1.

14. A vehicle having at least one radar device, comprising:
at least one antenna device that has at least one antenna arrangement for the at least one radar device,
wherein the at least one antenna arrangement has at least one type-1 antenna element of a first antenna element type and at least one type-2 antenna element of a second antenna element type, wherein one of the antenna element types is transmit antenna elements and the other of the antenna element types is receive antenna elements,
wherein the at least one radar device has at least one antenna device as claimed in claim 1.

15. A method for operating a radar device for a vehicle having at least one antenna device, which comprises at least one antenna arrangement that has at least one type-1 antenna element of a first antenna element type and at least one type-2 antenna element of a second antenna element type, wherein the method comprises:
using the antenna elements of one of the antenna element types to transmit radar signals and using the antenna elements of the other antenna element type to receive echo signals resulting from the transmitted radar signals,
wherein the radar signals are transmitted and the echo signals are received using an antenna device as claimed in claim 1.
